(19) United States
(12) Patent Application Publication
(10) Pub. No.: US 2011/0216554 A1
(43) Pub. Date: Sep. 8, 2011

(54) LIGHT EMITTING DEVICE

(75) Inventors: Yasushi HATTORI, Kanagawa (JP); Masaki Tohyama, Kanagawa (JP); Shinji Saito, Kanagawa (JP); Shinya Nunoue, Chiba (JP); Rei Hashimoto, Tokyo (JP); Jongil Hwang, Kanagawa (JP); Maki Sugai, Tokyo (JP); Takanobu Ueno, Kanagawa (JP); Junichi Kinoshita, Ehime (JP); Misaki Ueno, Kanagawa (JP)

(73) Assignees: Kabushiki Kaisha Toshiba, Tokyo (JP); Harison Toshiba Lighting Corp., Imabari-shi (JP)

(21) Appl. No.: 12/876,675

(22) Filed: Sep. 7, 2010

(30) Foreign Application Priority Data
Mar. 8, 2010 (JP) 2010-050664

(51) Int. Cl. F21V 7/22

(52) U.S. Cl. 362/606; 362/612

(57) ABSTRACT

An embodiment of the invention provides a light emitting device in which a semiconductor laser diode is used as a light source to efficiently obtain visible light having high uniformity of a luminance distribution. The light emitting device has a semiconductor laser diode that emits a laser beam. And the device has a light guide component that includes an upper surface, a lower surface, two side faces opposite each other, and two end faces opposite each other, the laser beam being incident from a first end face of the light guide component, the light guide component having indentation in the lower surface, the laser beam being reflected by the lower surface and emitted in an upper surface direction. The light emitting device also has a luminous component that is provided on an upper surface side of the light guide component and absorbs the laser beam emitted from the light guide component and emits visible light. And the device has a substance that is in contact with the lower surface and two side faces of the light guide component, a refractive index of the substance being lower than that of the light guide component.

### CROSS-REFERENCE TO RELATED APPLICATION

This application is based upon and claims the benefit of priority from Japanese Patent Application No. 2010-050664, filed on Mar. 8, 2010, the entire contents of which are incorporated herein by reference.

### FIELD

Embodiments described herein relate to a light emitting device.

### BACKGROUND

There have been proposed various light emitting devices in which a semiconductor light emitting element and a phosphor are combined. In such light emitting devices, the phosphor absorbs excitation light from the semiconductor light emitting element and emits light whose wavelength is different from that of the excitation light.

For example, there has been proposed a light emitting device, in which a laser beam emitted from the semiconductor laser diode is reflected by a light guide component and struck on a phosphor containing luminous component provided in an upper surface of the light guide component, thereby emitting visible light.

However, the proposed technique is not enough to efficiently improve uniformity of a luminance distribution of the visible light emitted from the luminous component.

### BRIEF DESCRIPTION OF THE DRAWINGS

FIG. 1 is a schematic sectional view illustrating a light emitting device according to a first embodiment of the invention;

FIG. 2 is a schematic perspective view illustrating the light emitting device of the first embodiment;

FIG. 3 is a sectional view illustrating a first example of a semiconductor laser diode;

FIG. 4 is a sectional view illustrating a second example of the semiconductor laser diode;

FIG. 5 is a sectional view illustrating a third example of the semiconductor laser diode;

FIG. 6 is an explanatory view illustrating an intensity distribution of a laser beam emitted from the semiconductor laser diode;

FIG. 7 is a view explaining function of the light emitting device of the first embodiment;

FIG. 8 is a view explaining function of the light emitting device of the first embodiment;

FIG. 9 is a sectional view illustrating an example of a luminous component of the first embodiment;

FIG. 10 is a partially sectional view illustrating an example of the luminous component of the first embodiment;

FIG. 11 is a schematic sectional view illustrating a light emitting device according to a second embodiment of the invention;

FIG. 12 illustrates a simulation result of a luminance distribution of visible light of the light emitting device of the second embodiment;

FIG. 13 illustrates an actual measurement result of the luminance distribution of visible light of the light emitting device of the second embodiment;

FIG. 14 is a schematic sectional view illustrating a light emitting device according to a third embodiment of the invention;

FIG. 15 is a schematic sectional view illustrating a light emitting device according to a fourth embodiment of the invention;

FIG. 16 is a schematic sectional view illustrating a light emitting device according to a fifth embodiment of the invention;

FIG. 17 is a schematic sectional view illustrating a light emitting device according to a sixth embodiment of the invention;

FIG. 18 is a schematic perspective view illustrating a planar light emitting device in which a light guide plate is combined with the light emitting device of the sixth embodiment; and

FIG. 19 is a schematic sectional view illustrating a light emitting device according to a seventh embodiment of the invention.

### DETAILED DESCRIPTION

An embodiment of the invention provides a light emitting device in which a semiconductor laser diode is used as a light source to efficiently obtain visible light having high uniformity of a luminance distribution. The light emitting device has a semiconductor laser diode that emits a laser beam. And the device has a light guide component that includes an upper surface, a lower surface, two side faces opposite each other, and two end faces opposite each other, the laser beam being incident from a first end face of the light guide component, the light guide component having indentation in the lower surface, the laser beam being reflected by the lower surface and emitted in an upper surface direction. The light emitting device also has a luminous component that is provided on an upper surface side of the light guide component and absorbs the laser beam emitted from the light guide component and emits visible light. And the device has a substance that is in contact with the lower surface and two side faces of the light guide component, a refractive index of the substance being lower than that of the light guide component. Embodiments of the invention will be described below with reference to the drawings. In the drawings, the identical or similar part is designated by the identical or similar numeral. For the sake of convenience, as used herein, in the light guide component, hereinafter a surface in which the laser beam is taken out is referred to as “upper surface”, and a surface opposite the upper surface is referred to as “lower surface”. As used herein, a refractive index shall mean an absolute refractive index when a refractive index in vacuum is set to 1.0.

### First Embodiment

A light emitting device according to a first embodiment of the invention includes: a semiconductor laser diode that emits a laser beam; a light guide component that includes an upper surface, a lower surface, two side faces opposite each other, and two end faces (first and second end faces) opposite each other, the laser beam being incident from a first end face of the light guide component, the light guide component having indentation or roughness in the lower surface, the laser beam being reflected by the lower surface and emitted from the upper surface; a luminous component that is provided on the upper surface side of the light guide component and absorbs the laser beam emitted from the light guide component and emits visible light; and a substance that is in contact with the lower surface and two side faces of the light guide component, a refractive index of the substance being lower than that of the light guide component. For example, the light emitting device is used as a backlight of a liquid crystal display. The substance may be gas such as an air.

In the light emitting device of the first embodiment, the indentation or roughness is provided in the lower surface of the light guide component according to an intensity distribution of the laser beam incident to the light guide component, thereby improving the uniformity of the intensity distribution of the laser beam incident to the light guide component. Therefore, the light emitting device that emits the visible light having the high uniformity of the luminance distribution is realized. The refractive index of the substance that is in contact with the lower surface and side faces of the light guide component is set lower than that of the light guide component, which allows the laser beam to be totally reflected in the light guide component. Accordingly, energy loss is reduced during the reflection, and the light emitting device having the high luminous efficiency can be realized.

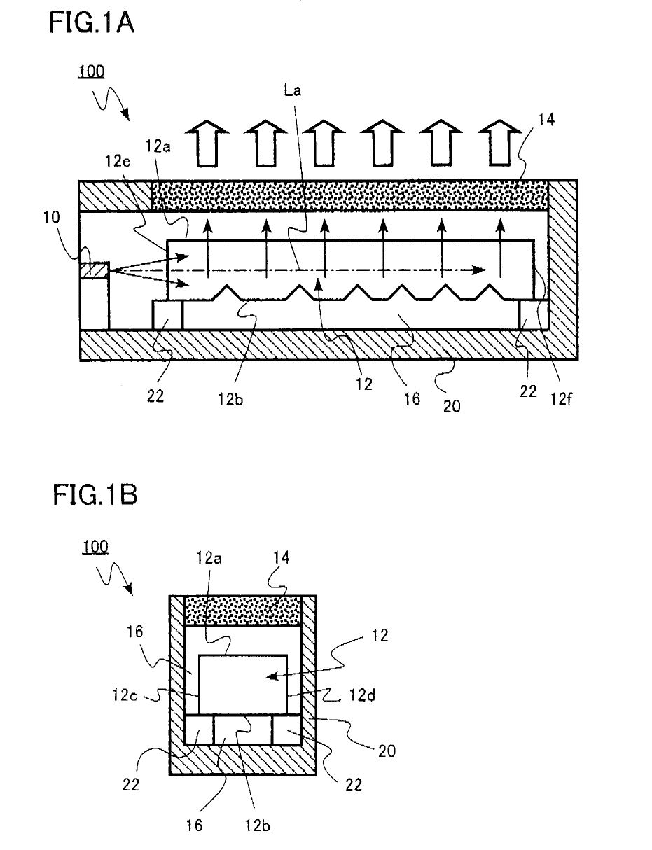

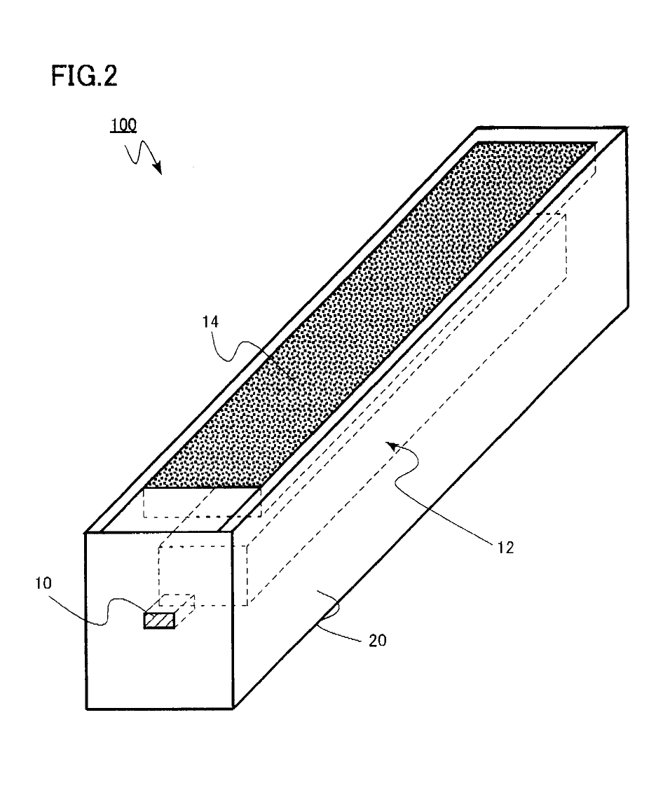

FIG. 1 is a schematic sectional view illustrating a light emitting device according to a first embodiment of the invention. FIG. 1A is a sectional view parallel to a center axis of the laser beam, and FIG. 1B is a sectional view perpendicular to the center axis of the laser beam. FIG. 2 is a schematic perspective view illustrating the light emitting device of the first embodiment.

A light emitting device 100 includes a semiconductor laser diode 10 that emits the laser beam (a solid-line arrow in FIG. 1) and a light guide component 12 to which the laser beam emitted from the semiconductor laser diode 10 is incident.

For example, the light guide component 12 is made of translucent glass such as quartz glass, and includes an upper surface 12a, a lower surface 12b, a first side face 12c and a second side face 12d that are opposite each other, and a first end face 12e and a second end face 12f that are opposite each other. The indentation is provided in the lower surface 12b of the light guide component 12. In the first embodiment, the indentation is linearly provided in a direction intersecting a center axis La (an arrow of an alternate long and short dash line of FIG. 1) of the laser beam, and a cross-section of the indentation has a wedge-shaped (triangular) groove. The laser beam is incident from the first end face 12e of the light guide component 12 and reflected by the lower surface 12b, and then emitted toward the direction of the upper surface 12a.

The light emitting device 100 includes a luminous component 14 that is provided on the side of the upper surface 12a of the light guide component 12. The luminous component 14 absorbs the laser beam emitted from the light guide component 12 and emits the visible light (a white arrow in FIG. 1). The light emitting device 100 also includes a substance 16 such as air. The substance 16 is in contact with the lower surface 12b, first side face 12c, and second side face 12d of the light guide component 12 made of glass, and a refractive index of the substance 16 is lower than that of the light guide component 12.

For example, the semiconductor laser diode 10 and the luminous component 14 are fixed to an aluminum chassis 20. The light guide component 12 is supported by a support portion 22 such that a hollow portion, that is, air is interposed between the light guide component 12 and an inner surface of the chassis 20. In the first embodiment, the light guide component 12 is formed into a long and thin rod shape that extends in the direction of the center axis La of the laser beam. The luminous component 14 is also formed into a long and thin shape that extends in the direction of the center axis La of the laser beam according to the light guide component 12. Accordingly, the light emitting device 100 linearly emits the visible light.

Desirably a semiconductor laser diode having an emission peak wavelength in a blue to ultraviolet wavelength region of 430 nm or less is used as the semiconductor laser diode 10. For example, an AlGaInN laser diode can be used as the semiconductor laser diode 10.

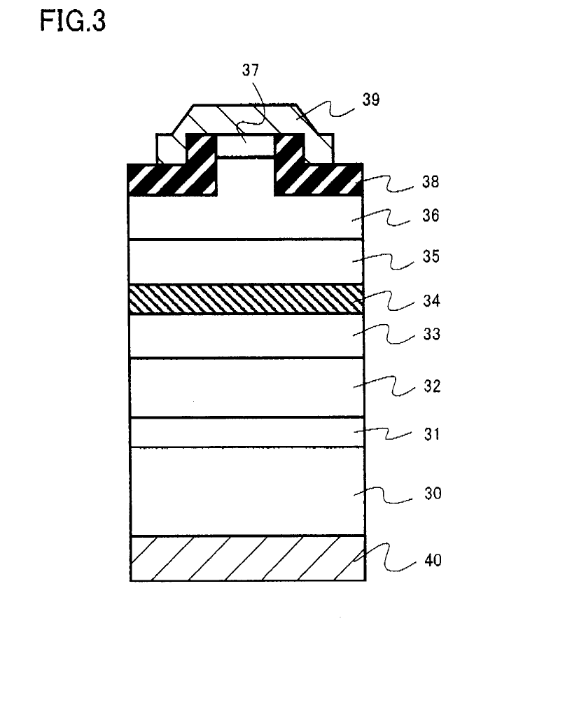

FIG. 3 is a sectional view illustrating a first example of the semiconductor laser diode. The semiconductor laser diode is an edge emitting AlGaInN laser diode in which GaInN that is a III-V compound semiconductor is used as a light emitting layer.

The semiconductor laser diode has a structure in which an n-type GaN buffer layer 31, an n-type AlGaN cladding layer 32, an n-type GaN optical guide layer 33, a GaInN light emitting layer 34, a p-type GaN optical guide layer 35, a p-type AlGaN cladding layer 36, and a p-type GaN contact layer 37 are sequentially stacked on an n-type GaN substrate 30. Insulating films 38 are provided on a ridge side face of the p-type GaN contact layer 37 and a surface of the p-type AlGaN cladding layer 36. A p-side electrode 39 is provided on surfaces of the p-type GaN contact layer 37 and the insulating film 38, and an n-side electrode 40 is provided on a rear surface of the n-type GaN substrate 30. The laser beam is emitted from the GaInN light emitting layer 34 by applying an operating voltage between the p-side electrode 39 and the n-side electrode 40.

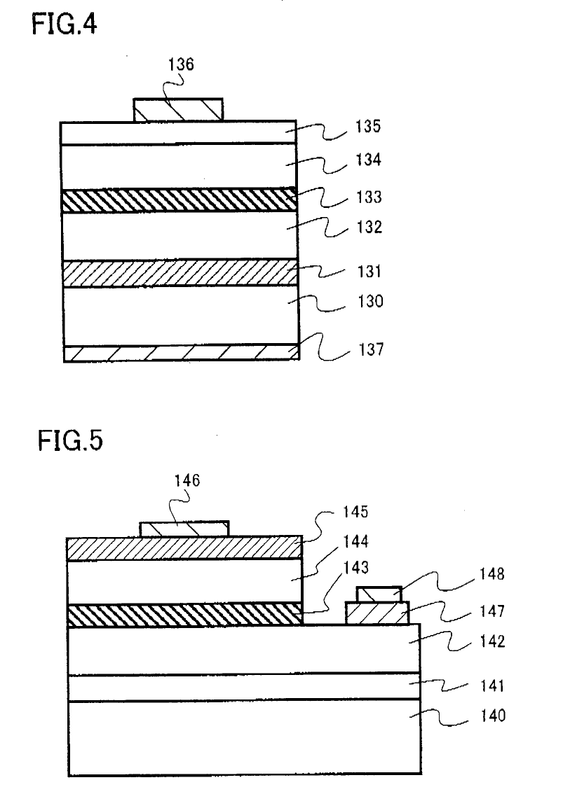

FIG. 4 is a sectional view illustrating a second example of the semiconductor laser diode. The semiconductor laser diode is an edge emitting MgZnO laser diode in which MgZnO that is a II-VI compound semiconductor is used as the light emitting layer.

The semiconductor laser diode has a structure in which a metallic reflecting layer 131, a p-type MgZnO cladding layer 132, an i-type MgZnO light emitting layer 133, an n-type MgZnO cladding layer 134, and an n-type MgZnO contact layer 135 are sequentially stacked on a zinc oxide (ZnO) substrate 130. An n-side electrode 136 is provided in the n-type contact layer 135. A p-side electrode 137 is provided on the substrate 130.

FIG. 5 is a sectional view illustrating a third example of the semiconductor laser diode. The semiconductor laser diode is also the edge emitting MgZnO laser diode in which MgZnO that is the II-VI compound semiconductor is used as the light emitting layer.

The semiconductor laser diode has a structure in which a ZnO buffer layer 141, a p-type MgZnO cladding layer 142, a MgZnO light emitting layer 143, and an n-type MgZnO cladding layer 144 are sequentially stacked on a Si substrate 140. An n-side electrode 146 is provided on the n-type cladding layer 144 with an Indium Tin Oxide (ITO) electrode layer 145 interposed therebetween. A p-side electrode 148 is provided on the p-type cladding layer 142 with an ITO electrode layer 147 interposed therebetween.

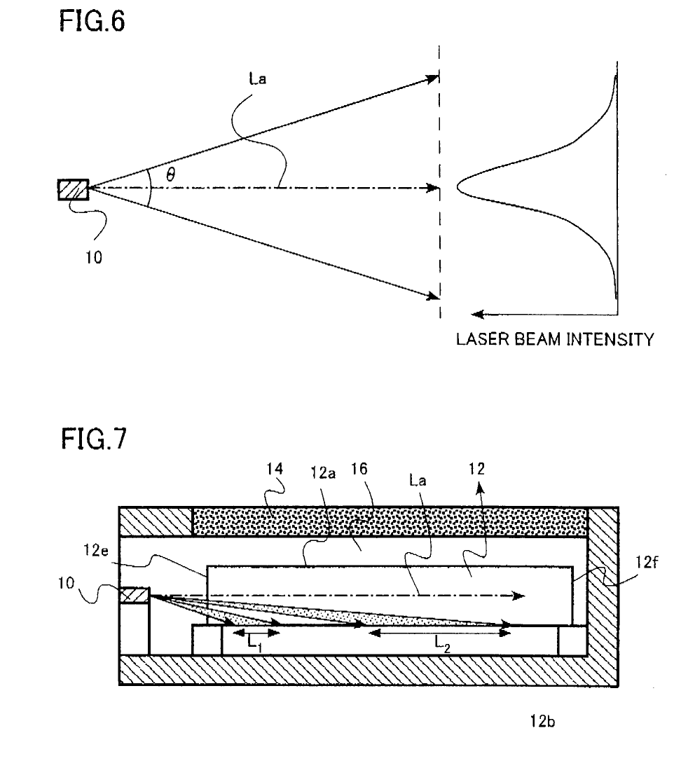

FIG. 6 is an explanatory view illustrating an intensity distribution of the laser beam emitted from the semiconductor laser diode. As illustrated in FIG. 6, for example, the laser beam emitted from the end face of the semiconductor laser diode 10 has a vertical spread angle θ of 60 degrees around the center axis La that is the maximum intensity direction of the laser beam. An intensity distribution of the laser beam may exhibit a Gaussian distribution in which the intensity on the center axis becomes an average value as illustrated in FIG. 6.

FIG. 7 is a view explaining function of the light emitting device of the first embodiment. Assuming that the intensity distribution of the laser beam is not the Gaussian distribution but a constant distribution, energy per unit area of the laser beam with which the lower surface of the light guide component 12 is illuminated becomes higher on the side of the semiconductor laser diode 10, because illumination regions of the two laser beams located in the same angle range becomes L₁<L₂ as illustrated in FIG. 7. That is, the energy becomes the maximum on the portion of the first end face 12e side, and decreases toward the portion of the second end face 12f side.

Accordingly, in order to improve the uniformity of the intensity distribution of the laser beam emitted toward the luminous component 14, desirably reflection efficiency of the laser beam toward the upper surface 12a at the second end face 12f side portion of the lower surface 12b of the light guide component 12 is larger than the first end face 12e side portion.

In the first embodiment, as illustrated in FIG. 1A, the indentation or roughness is provided in the lower surface 12b of the light guide component 12 to reflect the laser beam. The indentation or roughness becomes dense from the first end face 12e toward the second end face 12f, whereby the second end face 12f side portion of the lower surface 12b is larger than the first end face 12e side portion in the reflection efficiency of the laser beam.

Actually, because the intensity distribution of the laser beam becomes the Gaussian distribution, it is predicted that the energy on the first end face 12e side portion becomes lower than that of the constant distribution case. The optimum density of indentation or roughness in the light guide component 12 depends on a laser beam distribution, a distance between the semiconductor laser diode 10 and the light guide component 12, a size of the light guide component 12, and the like. Therefore, the optimum density of indentation or roughness may be set in consideration of various parameters.

FIG. 8 is a view explaining the function of the light emitting device of the first embodiment. A polygonal line in FIG. 8 indicates part of the lower surface 12b of the light guide component 12. The light emitting device 100 includes the substance 16 such as air. The substance 16 is in contact with the lower surface 12b, first side face 12c, and second side face 12d of the light guide component 12 made of glass, and the refractive index of the substance 16 is lower than that of the light guide component 12. It is assumed that n_{b} denotes a refractive index of the light guide component 12 and nₐ denotes a refractive index of the substance 16 that is lower than that of the light guide component 12. For example, quartz glass has a refractive index of about 1.5, and air has a refractive index of about 1.0.

When an incident angle θ of the laser beam (a solid-line arrow in FIG. 8) is not lower than a critical angle, that is, when sin θ≧nₐ/n_{b} is satisfied, the laser beam is totally reflected. For example, when a mirror or a diffuser plate is provided in the lower surface of the light guide component 12b to reflect the laser beam, the mirror or the diffuser plate partially absorbs the laser beam to generate the energy loss. The total reflection of the laser beam eliminates the laser beam energy loss caused by the reflection.

In the first embodiment, the indentation in the lower surface 12b of the light guide component 12 is designed such that the incident angle θ of the laser beam satisfies the condition of the total reflection as much as possible, which suppresses the laser beam energy loss caused by the reflection at the mirror or diffuser plate.

The design is made such that the reflection of the laser beam at the first side face 12c and second side face 12d becomes the total reflection as much as possible. Particularly, for the light emitting device of the first embodiment having a linear shape, because the light guide component 12 has the long and thin rod shape, the incident angle of the laser beam inevitably becomes shallow with respect to the first side face 12c and the second side face 12d. Accordingly, the condition of the total reflection is easily satisfied.

Thus, in the light emitting device of the first embodiment, the optical path of the laser beam is changed by utilizing the total reflection, thereby realizing the improvement of the uniformity of the emission intensity. Accordingly, the light emitting device having the high efficiency and small energy loss can be realized.

Preferably a ratio nₐ/n_{b} of the refractive index nₐ of the substance 16 that is lower than that of the light guide component 12 and the refractive index n_{b} of the light guide component 12 is minimized as much as possible because a degree of freedom of the design increases with decreasing critical angle at which the total reflection is generated.

Desirably translucent glass such as quartz glass is used as the material for the light guide component 12. The translucent glass is hardly altered even if the high-energy laser beam is incident thereto, and the translucent glass hardly absorbs the light. However, for example, transparent resin may be used as the material for the light guide component 12.

In the first embodiment, the long and thin rod-shaped light guide component 12 is used because the light emitting device 100 emits the linear visible light. The light guide component 12 may be formed into a plate shape, when the light emitting device 100 emits the planar visible light.

In consideration of the reflection efficiency of the laser beam, preferably the indentation is linearly provided in the direction intersecting the center axis La (the arrow of the alternate long and short dash line of FIG. 1) of the laser beam. For example, the indentation is not formed by the linear groove, but the indentation may be formed into another shape such as a pit shape. The sectional shape of the indentation is not limited to the wedge shape (triangular shape), but the optimum shape such as a trapezoid, a rectangular shape, and a semispherical shape may be selected as the sectional shape of the indentation so as to satisfy the even luminance distribution and the condition of the total reflection. The indentation may be provided in the linear shape or curved shape.

In the first embodiment, desirably the substance 16 is gas such as air because of the extremely low refractive index.

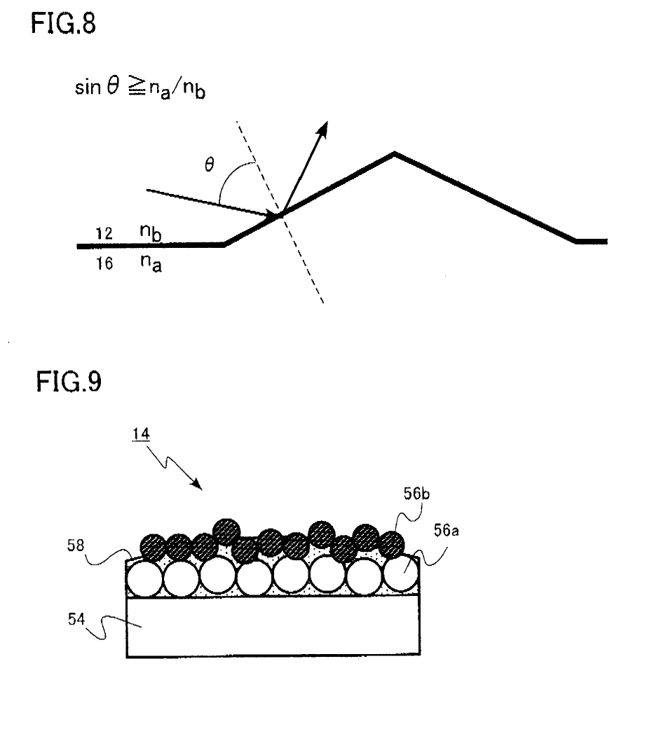

FIG. 9 is a sectional view illustrating an example of a luminous component of the first embodiment. The luminous component 14 is formed while first phosphor particles 56a and second phosphor particles 56b are bonded in the laminar shape on a transparent substrate 54 such as a transparent glass substrate by a bonding agent 58. The first phosphor particle 56a and the second phosphor particle 56b emit the pieces of visible light having different wavelengths.

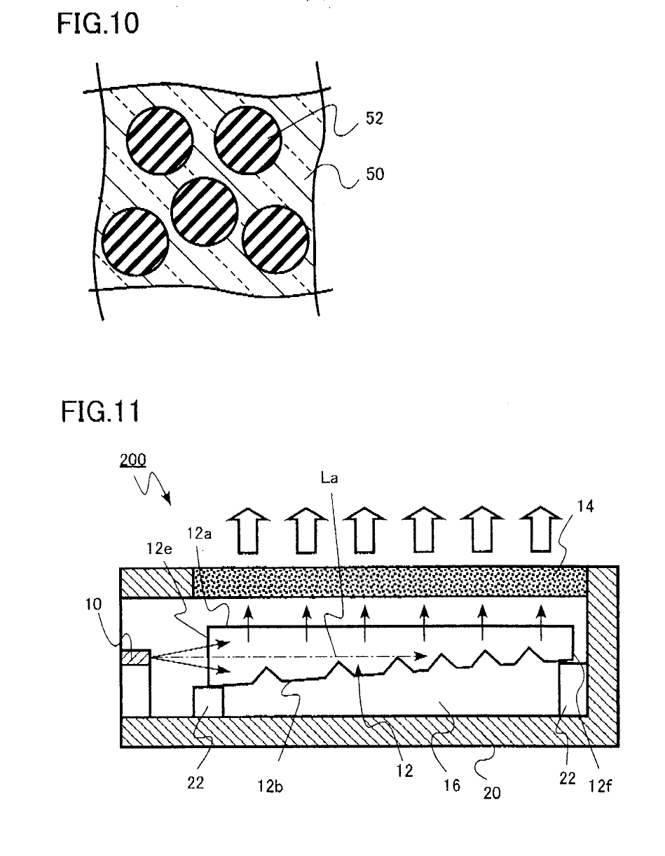

FIG. 10 is a partially sectional view illustrating an example of the luminous component of the first embodiment. The phosphor particles are not bonded on the glass substrate as illustrated in FIG. 9, but phosphor particles 52 may be dispersed in a transparent base material 50 such as a silicone resin as illustrated in FIG. 10.

The laser beam that is the excitation light incident to the luminous component 14 is absorbed by the phosphor particles and converted into the visible light whose wavelength is different from that of the excitation light.

For example, (Sr,Ca,Ba)₁₀(PO₄)₆Cl₂:Eu that is the blue luminous component and (Sr,Ca,Ba)₂Si₂O₄:Eu that is the yellow luminous component are used as the phosphor particles in order to emit the white light.

In the two kinds of the phosphor particles of FIG. 9, the yellow luminous component that emits the light having the longer wavelength is bonded onto the side closer to the light guide component 12, that is, onto the side of glass substrate 54 of FIG. 9, and the blue luminous component that emits the light having the shorter wavelength is bonded onto the yellow luminous component. The stacked structure reduces reabsorption of the light emitted from the blue luminous component by the yellow luminous component, which allows the improvement of the luminous efficiency.

Alternatively, as illustrated in FIG. 10, the two kinds of the phosphor particles are dispersed in the silicone resins, respectively, to form the two kinds of the luminous bodies, that is, yellow and blue luminous bodies. The two kinds of the luminous bodies may be stacked to form the luminous component 14. At this point, preferably the yellow luminous component is provided on the side closer to the light guide component 12.

When the luminous component 14 has the stacked structure, the luminous component having a high absorption factor of the laser beam is disposed on the side closer to the light guide component 12 instead of disposing the luminous component that emits the light having the longer wavelength on the side closer to the light guide component 12. Therefore, preferably a ratio of the laser beam returning onto the side of the light guide component 12 is reduced to improve the luminous efficiency.

In the first embodiment, the luminous component 14 is formed by the use of the two kinds of the phosphor particles. However, the kind of the phosphor particle and the number of kinds of the phosphor particles can appropriately be changed in accordance with the intended use. For example, the luminous component that emits the white light may be formed by the three kinds of the blue phosphor particle, the red phosphor particle, and the green phosphor particle.

Desirably the phosphor particle has a particle diameter ranging from 5 to 25 μm. Particularly particles having large diameters of about 20 μm or more are desirably used as the phosphor particle because of high emission intensity and high luminous efficiency. When the particle diameter of the phosphor particle is lower than 5 μm, the phosphor particle is not suitable for the use of the luminous component because of the low absorption factor of the particle and the easy degradation of the particle. When the particle diameter of the phosphor particle exceeds 25 μm, the luminous component 14 is hardly formed, and color unevenness is easily generated.

In the first embodiment, the gas is interposed between the luminous component 14 and the light guide component 12. Although the configuration of the first embodiment is desirable from the viewpoints of easy simulation of the laser beam path and increased design efficiency of the device, the light emitting device may be miniaturized by bringing the luminous component 14 and the light guide component 12 close to each other.

Part or the whole of the inner surface of the chassis 20 that is opposite the lower surface 12b, side face 12c, side face 12d, and second end face 12f of the light guide component 12 may be formed by a diffusion reflecting surface or mirror reflecting surface. At this point, because the light that is transmitted through the light guide component 12 while not totally reflected on the surface of the light guide component 12 can be reflected by the inner surface of the chassis 20 and reused, the luminous efficiency is improved as a whole. In the first embodiment, the gap is provided between the second end face 12f of the light guide component 12 and the inner surface of the chassis 20 that is opposite the second end face 12f. Alternatively, the gap is eliminated, and the second end face 12f may be assembled so as to be brought into close contact with the inner surface of the chassis 20. At this point, the light reaching the second end face 12f is reflected by the reflecting surface formed in the inner surface of the chassis 20, and the reflected light can be utilized as effective light.

As described above, according to the first embodiment, the light emitting device in which the semiconductor laser diode is used as the light source to efficiently obtain the visible light having the high uniformity of the luminance distribution is realized.

### Second Embodiment

A light emitting device according to a second embodiment of the invention is similar to that of the first embodiment except that the lower surface of the light guide component is inclined from the first end face toward the second end face such that a distance from the center axis of the laser beam is shortened. Accordingly, contents overlapping those of the first embodiment are omitted.

FIG. 11 is a schematic sectional view illustrating the light emitting device of the second embodiment. As illustrated in FIG. 11, in a light emitting device 200, the lower surface 12b of the light guide component 12 is inclined from the first end face 12e toward the second end face 12f such that the distance from the center axis La of the laser beam is shortened. That is, the lower surface 12b has a slope shape such that a thickness of the light guide component 12 decreases from the side of the semiconductor laser diode 10.

In the second embodiment, the laser beam leaking from the second end face 12f to the outside of the light guide component 12 is reduced. Accordingly, the energy loss further reduced compared with the first embodiment, and the high-efficiency light emitting device is realized.

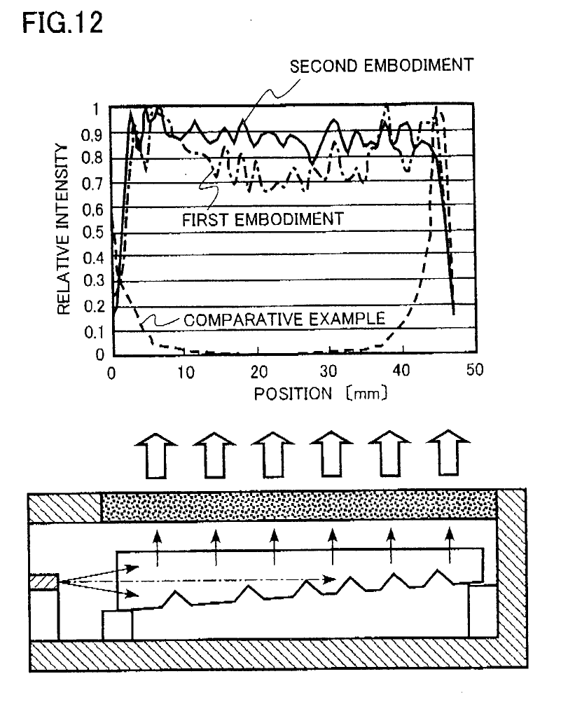

FIG. 12 illustrates a simulation result of a luminance distribution of the visible light of the light emitting device of the second embodiment. The laser diode having the wavelength of 400 nm is used as the light source, and quartz glass having a width of 2 mm and a length of 50 mm is used as the light guide component 12. The first end face 12e of the light guide component 12 is set to a height of 1.6 mm, and the second end face 12f is set to a height of 0.5 mm, whereby the light guide component 12 has a slope shape. A horizontal axis of FIG. 12 indicates a position (mm) of a measurement point based on the first end face 12e of the light guide component 12, and a vertical axis indicates a relative luminance (−) normalized by the maximum luminance. Simulation results of the first embodiment in which the slope is eliminated in the light guide component 12 and a comparative example in which the slop and the indentation are eliminated in the light guide component 12 are also illustrated for the purpose of comparison. As illustrated in FIG. 12, the visible light having the highly even luminance distribution is obtained in the first embodiment, and the visible light having the extremely highly even luminance distribution is obtained by the light emitting device 200 of the second embodiment.

FIG. 13 illustrates an actual measurement of the luminance distribution of the visible light of the light emitting device of the second embodiment. An edge emitting AlGaInN laser diode in which GaInN is used as the light emitting layer is used as the semiconductor laser diode 10, and the edge emitting AlGaInN laser diode emits the laser beam having the wavelength of 400 nm. The quartz glass having the width of 2 mm and the length of 60 mm is used as the light guide component 12. The horizontal axis indicates the luminance of the visible light in linear scale. As illustrated in FIG. 13, the visible light having the extremely highly even luminance distribution is obtained in the light emitting device 200 of the second embodiment.

### Third Embodiment

A light emitting device according to a third embodiment of the invention is similar to that of the first embodiment except that the light emitting device further includes a diffusion component on the second end face side of the light guide component. Accordingly, contents overlapping those of the first embodiment are omitted.

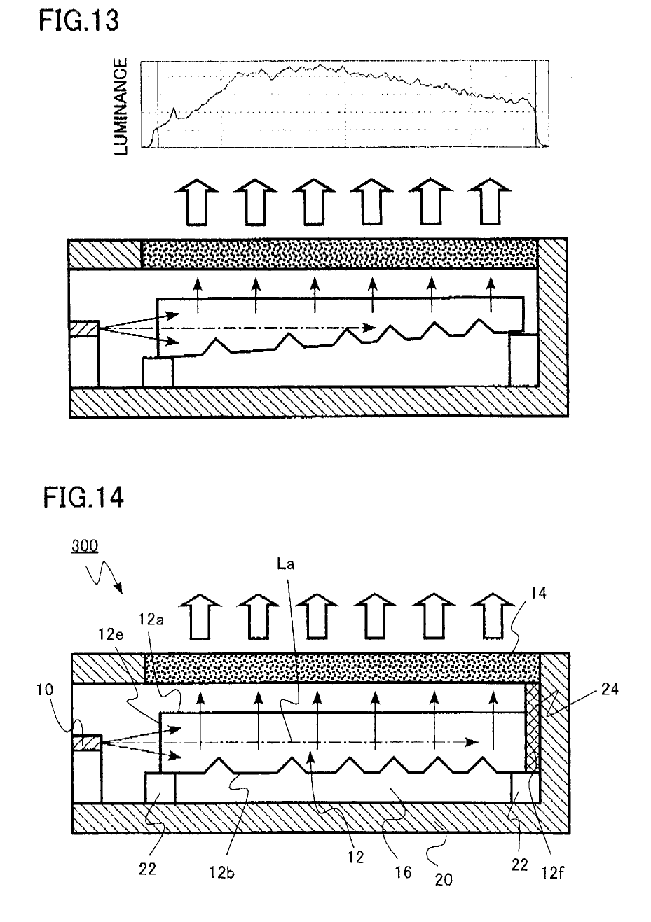

FIG. 14 is a schematic sectional view illustrating the light emitting device of the third embodiment. As illustrated in FIG. 14, a light emitting device 300 includes a diffusion component 24 on the side of the second end face 12f of the light guide component 12. For example, the diffusion component 24 is a white diffusion reflecting material made of zinc oxide.

In the third embodiment, the diffusion component 24 is provided to return the laser beam reaching the second end face 12f onto the side of the light guide component 12, which contributes to the light emission of the luminous component 14. Accordingly, the energy loss further reduced compared with the first embodiment, and the high-efficiency light emitting device is realized.

In the third embodiment, desirably the shape of the indentation of the lower surface 12b is designed in consideration of the laser beam that is returned onto the side of the light guide component 12 by the diffusion component 24.

### Fourth Embodiment

Alight emitting device according to a fourth embodiment of the invention is similar to that of the first embodiment except that the light emitting device further includes a reflecting component on the second end face side of the light guide component. Accordingly, contents overlapping those of the first embodiment are omitted.

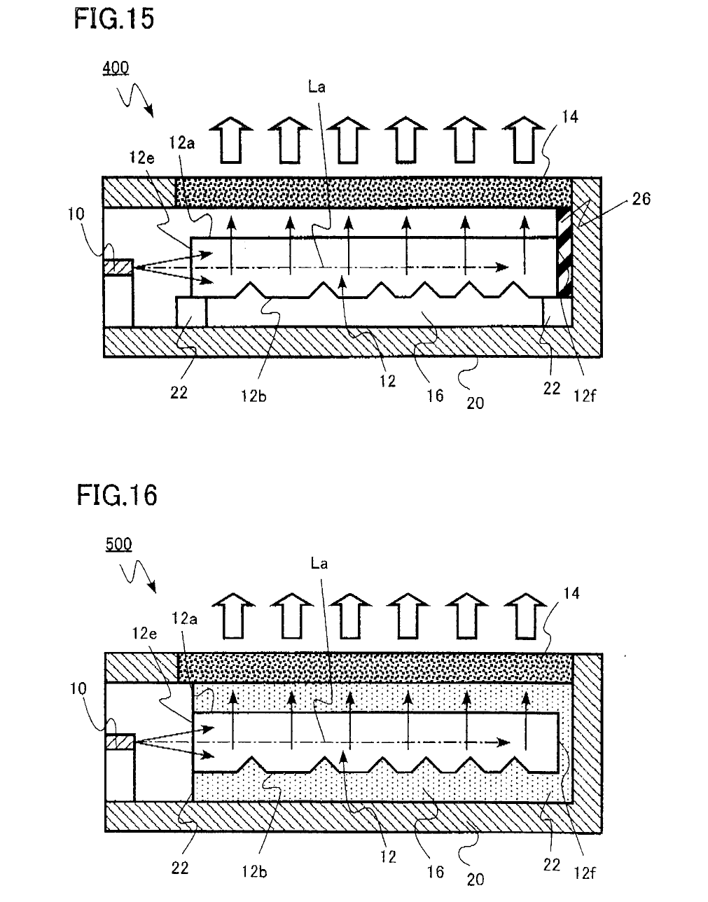

FIG. 15 is a schematic sectional view illustrating the light emitting device of the fourth embodiment. As illustrated in FIG. 15, a light emitting device 400 includes a reflecting component 26 on the side of the second end face 12f of the light guide component 12. For example, the reflecting component 26 is a mirror that is configured to reflect the wavelength of the laser beam using a dielectric multilayer film.

In the fourth embodiment, the reflecting component 26 is provided to return the laser beam reaching the second end face 12f onto the side of the light guide component 12, which contributes to the light emission of the luminous component 14. Accordingly, the energy loss further reduced compared with the first embodiment, and the high-efficiency light emitting device is realized.

In the fourth embodiment, similarly to the third embodiment, desirably the shape of the indentation of the lower surface 12b is designed in consideration of the laser beam that is returned onto the side of the light guide component 12 by the reflecting component 26.

### Fifth Embodiment

A light emitting device according to a fifth embodiment of the invention is similar to that of the first embodiment except that the substance having the low refractive index is not the air but resin having a low refractive index. Accordingly, contents overlapping those of the first embodiment are omitted.

FIG. 16 is a schematic sectional view illustrating the light emitting device of the fifth embodiment. As illustrated in FIG. 16, in a light emitting device 500, the substance 16 that is in contact with the lower surface 12b and two side faces 12c and 12d of the light guide component 12 has the refractive index lower than that of the light guide component 12, and the substance 16 is formed by the low-refractive-index resin such as a fluorine resin.

In the fifth embodiment, the low-refractive-index substance 16 is formed by not gas such as air, but a solid substance, so that the light guide component 12 can firmly be fixed to the chassis 20. Accordingly, compared with the first embodiment, the light emitting device having excellent mechanical strength is easily produced.

### Sixth Embodiment

Alight emitting device according to a second embodiment of the invention is similar to that of the sixth embodiment except that the light emitting device further includes an optical fiber as an optical member placed between the semiconductor laser diode and the light guide component. The optical fiber changes an optical path or a direction of the laser beam. Contents overlapping those of the first embodiment are omitted.

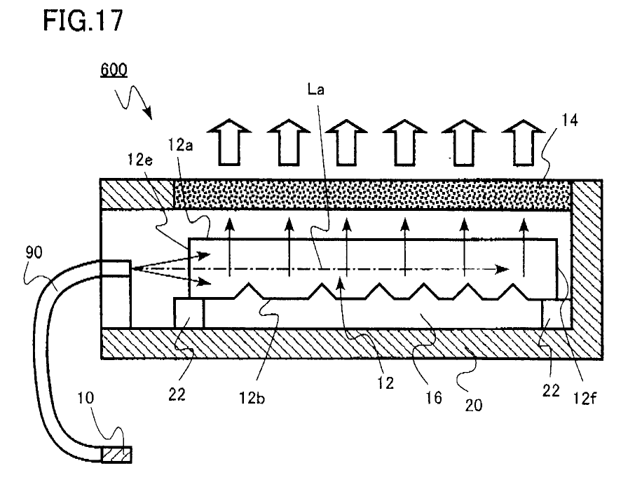

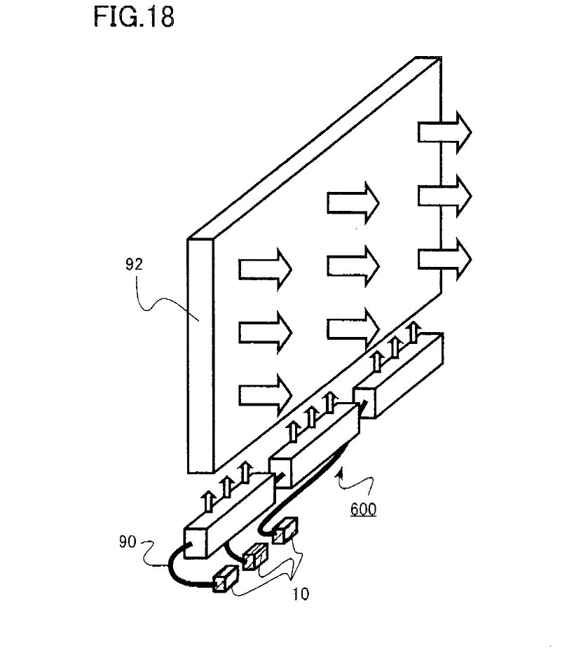

FIG. 17 is a schematic sectional view illustrating the light emitting device of the sixth embodiment. As illustrated in FIG. 17, in a light emitting device 600, an optical fiber 90 through which the laser beam propagates is provided between the semiconductor laser diode 10 and the light guide component 12.

In the sixth embodiment, semiconductor laser diode 10 having the maximum amount of heat generation can freely be disposed while separated from the light emitting section. Accordingly, the light emitting device having a high degree of freedom of the design such as the disposition of the light emitting section is realized. For example, the light emitting device having the excellent heat radiation performance compared with the first embodiment can be realized by disposing the semiconductor laser diode 10 on a heat sink.

FIG. 18 is a schematic perspective view illustrating a planar light emitting device in which a light guide plate is combined with the light emitting device of the sixth embodiment. In the planar light emitting device, three light emitting devices 600 are disposed in series in a lower-side end face of a light guide plate 92. The visible light input from the lower-side end face of the light guide plate 92 diffuse in the light guide plate 92, and the light is emitted on the side face of the light guide plate 92. As illustrated in FIG. 18, the three semiconductor laser diodes 10 are collected into one point and disposed in one heat sink, which implements the planar light emitting device having the excellent heat radiation performance.

In a configuration of FIG. 18, by way of example, the light emitting device 600 is used to implement the thermally-favored planar light emitting device. Alternatively, each of the light emitting devices 100 to 500 may be used instead of the light emitting device 600 to implement the planar light emitting device having another high degree of freedom of the design.

### Seventh Embodiment

A light emitting device according to a seventh embodiment of the invention is similar to that of the second embodiment except that the light emitting device further includes a optical lens as the optical member that changes the optical path of the laser beam a between the semiconductor laser diode and the light guide component and a reflecting component on the second end face side of the light guide component. Accordingly, contents overlapping those of the second embodiment are omitted.

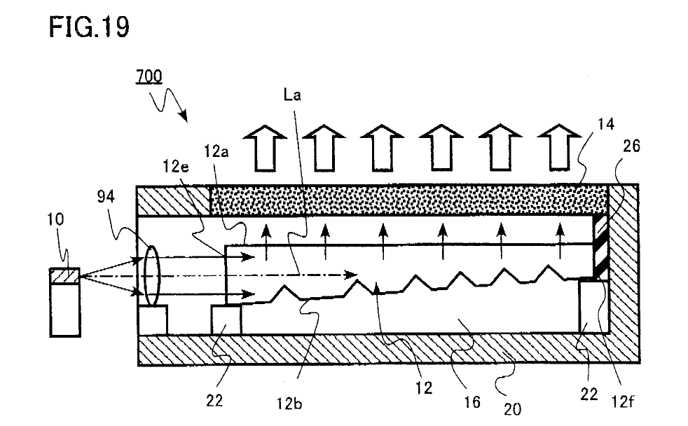

FIG. 19 is a schematic sectional view illustrating the light emitting device of the seventh embodiment. As illustrated in FIG. 19, in a light emitting device 700, for example, an optical lens 94 that causes the laser beam to converge to form a parallel light beam is provided between the semiconductor laser diode 10 and the light guide component 12. The light emitting device 700 includes the reflecting component 26 on the side of the second end face 12f of the light guide component 12. For example, the reflecting component 26 is the mirror that is configured to reflect the wavelength of the laser beam using the dielectric multilayer film.

In the seventh embodiment, the optical lens 94 causes the laser beam to converge, whereby the laser beam can propagate through the light guide component 12 for a long distance while the energy of the laser beam is maintained. Accordingly, the light emitting device in which the light guide component 12 longer and thinner than those of the second embodiment is applied to obtain the visible light having the emission shape longer and thinner than those of the second embodiment can be realized. Because the optical lens 94 causes the laser beam to converge to increase a light quantity of the laser beam reaching the side of the second end face 12f, advantageously the reflecting component 26 is provided from the viewpoint of the reduction of the energy loss.

In the seventh embodiment, the optical lens 94 causes the laser beam to converge by way of example. For example, the optical lens may be used to spread the laser beam when the light guide component 12 is formed into the plate shape to form the planar light emitting device.

While certain embodiments have been described, these embodiments have been presented by way of example only, and are not intended to limit the scope of the inventions. Indeed, the light emitting devices described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

For example, in the embodiments, the light emitting device includes the luminous component that emits the white light. The invention is not limited to the light emitting device including the luminous component that emits the white light, but the invention can be applied to a light emitting device including a luminous component that emits the visible light having another color. For example, a luminous component that emits the visible light having a color such as red, orange, yellow, yellow-green, green, blue-green, blue, and violet can be used as usage.

In the embodiments, the luminous component is formed into the rectangular shape. The luminous component is not limited to the rectangular shape, but the luminous bodies having various shapes may be used.

The application of the light emitting device is not limited to the backlight of the liquid crystal display for the television or personal computer, but examples of the application of the light emitting device includes a general lighting apparatus, a professional-use lighting apparatus, and a light for an automobile, a motorcycle, or a bicycle.

The AlGaInN laser diode in which the light emitting layer is made of GaInN is used in the embodiments. Aluminum nitride/gallium nitride/indium nitride (AlGaInN) that is a III-V compound semiconductor or magnesium oxide/zinc oxide (MgZnO) that is a II-VI compound semiconductor can be used as the light emitting layer (active layer). For example, the III-V compound semiconductor used as the light emitting layer is a nitride semiconductor that contains at least one element selected from a group consisting of Al, Ga, and In. Specifically the nitride semiconductor is expressed by AlₓGa_{y}In_{(1-x-y)}N (0≦x≦1, 0≦y≦1, 0≦(x+y)≦1). The nitride semiconductor includes binary semiconductors such as AlN, GaN, and InN, ternary semiconductors such as AlₓGa₍₁₋ₓ₎N (0<x<1), AlₓIn₍₁₋ₓ₎N (0<x<1), and Ga_{y}In_{(1-y)}N (0<y<1), and quaternary semiconductors including all the elements. The emission peak wavelength is determined in the range of ultraviolet to blue based on compositions x, y, and (1-x-y) of Al, Ga, and In. Part of the III-group element can be substituted for boron (B), thallium (Tl), and the like. Fart of N that is the V-group element can be substituted for phosphorous (P), arsenic (As), antimony (Sb), bismuth (Bi) and the like.

Similarly, an oxide semiconductor containing at least one of Mg and Zn can be used as the II-VI compound semiconductor that is used as the light emitting layer. Specifically, the oxide semiconductor expressed by Mg₂Zn_{(1-z)}O (0≦z≦1) is used as the II-VI compound semiconductor, and the emission peak wavelength in the ultraviolet region is determined based on compositions z and (1-z) of Mg and Zn.

The silicone resin is used as the transparent base material of the phosphor in the embodiments. Alternatively, any material having the high permeability of the excitation light and a high heat-resistant property may be used as the transparent base material. In addition to silicone resin, examples of the material include an epoxy resin, a urea resin, a fluorine resin, an acrylic resin, and a polyimide resin. Particularly the epoxy resin or the silicone resin is suitably used because of easy availability, easy handling, and low cost. A ceramic structure in which glass, a sintered body, or Yttrium Aluminum Garnet (YAG) and alumina (Al₂O₃) are combined may be used in addition to the resins.

The phosphor particle is made of a material that absorbs the light having the wavelength region of ultraviolet to blue to emit the visible light. For example, phosphors such as a silicate phosphor, an aluminate phosphor, a nitride phosphor, a sulfide phosphor, an oxysulfide phosphor, a YAG phosphor, a borate phosphor, a phosphate-borate phosphor, a phosphate phosphor, and a halophosphate phosphor can be used. The compositions of the phosphors are shown below.

(1) Silicate Phosphor: (Sr_{(1-x-y-x)}BaₓCa_{y}Eu₂)₂Si_{w}O_{(2+2w)} (0≦x<1, 0≦y<1, 0.05≦z≦0.2, and 0.90≦w≦1.10)

The compositions of x=0.19, y=0, z=0.05, and w=1.0 is desirable in the silicate phosphor expressed by the chemical formula. In order to stabilize the crystal structure or enhance the emission intensity, part of strontium (Sr), barium (Ba), and calcium (Ca) may be substituted for at least one of Mg and Zn. For example, MSiO₃, MSiO₄, M₂SiO₃, M₂SiO₅, and M₄Si₂O₈ (M is at least one element that is selected from a group consisting of Sr, Ba, Ca, Mg, Be, Zn, and Y) can be used as the silicate phosphor having another composition ratio. In order to control the emission color, part of Si may be substituted for germanium (Ge) (for example, (Sr_{(1-x-y-z)}BaₓCa_{y}Eu_{z})₂(Si₍₁₋ᵤ₎Geᵤ) O₄). At least one element that is selected from a group consisting of Ti, Pb, Mn, As, Al, Pr, Tb, and Ce may be contained as the activation agent.

(2) Aluminate Phosphor; M₂Al₁₀O₁₇ (where Ni is at Least One element that is selected from a group consisting of Ba, Sr, Mg, Zn, and Ca)

At least one element of Eu and Mn is contained as the activation agent. For example, MAl₂O₄, MAl₄O₁₇, MAl₈O₁₃, MAl₁₂O₁₉, M₂Al₁₉O₁₇, M₂Al₁₁O₁₉, M₃Al₅O₁₂, M₃Al₁₆O₂₇, and M₄Al₅O₁₂ (M is at least one element that is selected from a group consisting of Ba, Sr, Ca, Mg, Be, and Zn) can be used as the aluminate phosphor having another composition ratio. At least one element that is selected from a group consisting of Mn, Dy, Tb, Nd, and Ce may be contained as the activation agent.

(3) Nitride Phosphor (Mainly Silicon Nitride Phosphor): LₓSi_{y}N_{(2x/3+4y/3)}:Eu or LₓSi_{y}O_{z}N_{(2x/3+4y/3-2z/3)}:Eu (L is at least one element that is selected from a group consisting of Sr, Ca, Sr, and Ca)

Although the compositions of x=2 and y=5 or x=1 and y=7 are desirable, x and y can be set to arbitrary values. Desirably phosphors such as (SrₓCa₍₁₋ₓ₎)₂Si₅N₈:Eu, Sr₂Si₅N₈:Eu, Ca₂Si₅N₈:Eu, SrₓCa₍₁₋ₓ₎Si₇N₁₀:Eu, SrSi₇N₁₀:Eu, and CaSi₇N₁₀:Eu in which Mn is added as the activation agent are used as the nitride phosphor expressed by the chemical formulas. The phosphors may contain at least one element that is selected from a group consisting of Mg, Sr, Ca, Ba, Zn, B, Al, Cu, Mn, Cr, and Ni. At least one element that is selected from a group consisting of Ce, Pr, Tb, Nd, and La may be contained as the activation agent.

(4) Sulfide Phosphor: (Zn₍₁₋ₓ₎Cdₓ)S:M (M is at Least One Element that is selected from a group consisting of Cu, Cl, Ag, Al, Fe, Cu, Ni, and Zn, and x is a Numerical Value Satisfying 0≦x≦1)

S may be substituted for at least one of Se and Te.

(5) Oxysulfide Phosphor: (Ln₍₁₋ₓ₎Euₓ)O₂S (Ln is at least one element that is selected from a group consisting of Sc, Y, La, Gd, and Lu, and x is a numerical value satisfying 0≦x≦1)

At least one element that is selected from a group consisting of Tb, Pr, Mg, Ti, Nb, Ta, Ga, Sm, and Tm may be contained as the activation agent.

(6) YAG Phosphor:

(Y_{(1-x-y-z)}GdₓLa_{y}Sm_{z})₃(Al₍₁₋ᵥ₎)Gaᵥ)₅O₁₂:Ce, Eu (0≦x≦1, 0≦y≦1, 0≦z≦1, 0≦v≦1)

At least one of Cr and Tb may be contained as the activation agent.

(7) Borate Phosphor: MBO₃:Eu (M is at Least One Element that is Selected from a Group Consisting of Y, La, Gd, Lu, and In)

Tb may be contained as the activation agent. For example, Cd₂B₂O5₅:Mn, (Ce,Gd,Tb)MgB₅O₁₀:Mn, and GdMgB₅O₁₀:Ce,Tb can be used as the borate phosphor having another composition ratio.

(8) Phosphate-Borate Phosphor:

2(M₍₁₋ₓ₎M′ₓ)O.aP₂O₅.bB₂O₃ (M is at Least One Element that is Selected from a Group Consisting of Mg, Ca, Sr, Ba, and Zn, M′ is at Least One element that is selected from a group consisting of Eu, Mn, Sn, Fe, and Cr, and x, a, and b are Numerical Values Satisfying 0.001≦x≦0.5, 0≦a≦2, 0≦b≦3, and 0.3<(a+b))

(9) Phosphate Phosphor: (Sr₍₁₋ₓ₎Baₓ)₃(PO₄)₂:Eu or (Sr₍₁₋ₓ₎Baₓ)₂P₂O₇:Eu,Sn

At least one of Ti and Cu may be contained as the activation agent.

(10) Halophosphate Phosphor: (M₍₁₋ₓ₎Euₓ)₁₀(PO₄)₆Cl₂ or (M₍₁₋ₓ₎Euₓ)₅(PO₄)₃C1 (M is at Least One Element that is Selected from a Group Consisting of Ba, Sr, Ca, Mg, and Cd, and x is a Numerical Value Satisfying 0≦x≦1)

At least part of Cl may be substituted for fluorine (F). At least one of Sb and Mn may be contained as the activation agent.

The phosphor can be used as a blue phosphor (or a blue luminous component), a yellow phosphor (or a yellow luminous component), a green phosphor (or a green luminous component), a red phosphor (or a red luminous component), and a white phosphor (or a white luminous component) by appropriately selecting the phosphor. The luminous component that emits light having an intermediate color can be formed by combining plural kinds of phosphors. The white luminous component may be formed by combining phosphors having colors corresponding to red, green, and blue (RGB) that are three primary colors of the light, or by combining colors having a complementary color relationship like blue and yellow.

For the combinations of the phosphor particles, the luminous component in which plural kinds of the phosphor particles are mixed may be used, or the plural kinds of the phosphors may be formed into a laminar structure in which the phosphors are stacked layer by layer. For example, the phosphor particle layers having the colors corresponding to the RGB color are stacked and formed as the layers corresponding to the RGB colors in the luminous component. At this point, the layer that emits the light having the shorter wavelength is disposed close to the semiconductor laser diode, thereby obtaining the light emitting device that efficiently emits the white light. The light emitting device in which the luminous component emits the white light is obtained even if the RGB phosphor particles are mixed in the transparent base material.

What is claimed is:

1. A light emitting device comprising:
a semiconductor laser diode emitting a laser beam;
a light guide component having an upper surface, a lower surface, two side faces opposite each other, and first and second end faces opposite each other, the laser beam being incident from the first end face of the light guide component, the light guide component having indentation in the lower surface, the laser beam being reflected by the lower surface and emitting from the upper surface;
a luminous component being provided on the upper surface side of the light guide component and absorbs the laser beam emitted from the light guide component and emits visible light; and
a substance being in contact with the lower surface and two side faces of the light guide component, a refractive index of the substance being lower than that of the light guide component.

2. The device according to claim 1, wherein the substance is gas.

3. The device according to claim 1, wherein the light guide component is made of glass.

4. The device according to claim 1, wherein the indentation of the lower surface is linearly provided in a direction intersecting a center axis of the laser beam.

5. The device according to claim 1, wherein the indentation of the lower surface becomes dense from the first end face toward the second end face.

6. The device according to claim 1, wherein the lower surface is inclined from the first end face toward the second end face such that a distance from a center axis of the laser beam is shortened.

7. The device according to claim 1, further comprising a diffusion component or a reflecting component on the second end face side of the light guide component.

8. The device according to claim 1, further comprising an optical member placed between the semiconductor laser diode and the light guide component, the optical member changes a direction of the laser beam.

9. The device according to claim 1, wherein the luminous component is a transparent substrate containing phosphor particles.

10. A light emitting device comprising:
a semiconductor laser diode emitting a laser beam;
a light guide component having a first end face perpendicular to a center axis of the laser beam, a second end face opposite the first end face, an upper surface parallel to the center axis, a lower surface, and two side faces that is parallel to the center axis and opposite each other, the light guide component having indentation inclined with respect to the center axis in the lower surface;
a luminous component having a phosphor being provided on the upper surface side of the light guide component; and
a substance being in contact with the lower surface and two side surfaces of the light guide component, a refractive index of the substance being lower than that of the light guide component.

11. The device according to claim 10, wherein the substance is gas.

12. The device according to claim 10, wherein the light guide component is made of glass.

13. The device according to claim 10, wherein the indentation of the lower surface is linearly provided in a direction intersecting the center axis of the laser beam.

14. The device according to claim 10, wherein the indentation of the lower surface becomes dense from the first end face toward the second end face.

15. The device according to claim 10, wherein the lower surface is inclined from the first end face toward the second end face such that a distance from a center axis of the laser beam is shortened.

16. The device according to claim 10, further comprising a diffusion component or a reflecting component on the second end face side of the light guide component.

17. The device according to claim 10, further comprising an optical member placed between the semiconductor laser diode and the light guide component, the optical member changes a direction of the laser beam.

18. The device according to claim 10, wherein the luminous component is a transparent substrate containing phosphor particles.
